(19) United States
(12) Patent Application Publication
(10) Pub. No.: US 2024/0229423 A1
(43) Pub. Date: Jul. 11, 2024

(54) ELECTRIC EXCAVATOR

(71) Applicant: KOMATSU LTD., Minato-ku, Tokyo (JP)

(72) Inventors: Masaho YAMAGUCHI, Minato-ku, Tokyo (JP); Hirotaka SUEYOSHI, Minato-ku, Tokyo (JP); Masaki YAMANAKA, Minato-ku, Tokyo (JP); Takeshi KITAGAWA, Minato-ku, Tokyo (JP); Takaki OKAMOTO, Minato-ku, Tokyo (JP); Kota WATANABE, Minato-ku, Tokyo (JP)

(73) Assignee: KOMATSU LTD., Minato-ku, Tokyo (JP)

(21) Appl. No.: 18/285,712

(22) PCT Filed: Mar. 25, 2022
(86) PCT No.: PCT/JP2022/014472

§ 371 Date: Oct. 5, 2023

(30) Foreign Application Priority Data
Apr. 15, 2021 (JP) 2021-069128

(51) Int. Cl. E02F 9/22; E02F 9/08; E02F 9/20

(52) U.S. Cl. CPC E02F 9/2296; E02F 9/0883; E02F 9/207

(57) ABSTRACT

A revolving frame revolves around a center of revolution. A battery is supported by the revolving frame. An electric motor is supported by the revolving frame and supplied with electric power from the battery. A hydraulic pump is supported by the revolving frame, driven by the electric motor, and arranged closer to the center of revolution than the electric motor in a plan view.

### TECHNICAL FIELD

The present disclosure relates to an electric excavator.

### BACKGROUND ART

Conventionally, a battery-powered electric excavator has been disclosed in, for example, Japanese Patent Laying-Open No. 11-140906 (PTL 1) and Japanese Patent Laying-Open No. 2012-1933 (PTL 2). Each of PTLs 1 and 2 discloses a small-sized electric excavator in which a battery, an electric motor and a hydraulic pump are arranged in this order from a rear part toward a front part of a revolving unit.

### CITATION LIST

### Patent Literature

PTL 1: Japanese Patent Laying-Open No. 11-140906
PTL 2: Japanese Patent Laying-Open No. 2012-1933

### SUMMARY OF INVENTION

### Technical Problem

A battery is arranged in a rear part of a revolving unit in order to also serve as a counterweight. However, in the case of a large-sized battery-powered electric excavator (hereinafter referred to as “electric excavator”), the battery occupies large space. Therefore, the battery protrudes into a machine compartment from the region where the battery is arranged as a counterweight, which makes it difficult to arrange the necessary components such as an electric motor and a hydraulic pump in the machine compartment. Thus, when the arrangement of the battery, the electric motor and the hydraulic pump as described in each of PTLs 1 and 2 is applied to the large-sized electric excavator, a hydraulic pipe becomes longer and a loss of oil pressure occurs, which leads to a decrease in energy efficiency.

An object of the present disclosure is to provide an electric excavator in which a length of a hydraulic pipe can be shortened.

### Solution to Problem

An electric excavator according to the present disclosure includes: a hydraulic actuator; a revolving frame; a battery; an electric motor; and a hydraulic pump. The revolving frame revolves around a center of revolution. The battery is supported by the revolving frame. The electric motor is supported by the revolving frame and driven by using the battery as a power source. The hydraulic pump is supported by the revolving frame, driven by the electric motor to supply oil to the hydraulic actuator, and arranged closer to the center of revolution than the electric motor in a plan view.

### Advantageous Effects of Invention

The present disclosure can implement an electric excavator in which a length of a hydraulic pipe can be shortened.

### BRIEF DESCRIPTION OF DRAWINGS

FIG. 1 is a perspective view schematically showing a configuration of an electric excavator according to an embodiment of the present disclosure.

FIG. 2 is a perspective view showing configurations of a revolving frame and components mounted thereon in the electric excavator shown in FIG. 1.

FIG. 3 is a plan view showing the configurations of the revolving frame and the components mounted thereon in the electric excavator shown in FIG. 1.

FIG. 4 is a side view showing a state in which a hydraulic pump is arranged under a hydraulic oil tank.

### DESCRIPTION OF EMBODIMENTS

Hereinafter, an embodiment of the present disclosure will be described with reference the drawings.

In the specification and the drawings, the same or corresponding components are denoted by the same reference characters, and the description thereof will not be repeated. In the drawings, some configurations may be omitted or simplified for convenience of description. At least some of the embodiment and the modifications may be optionally combined with each other.

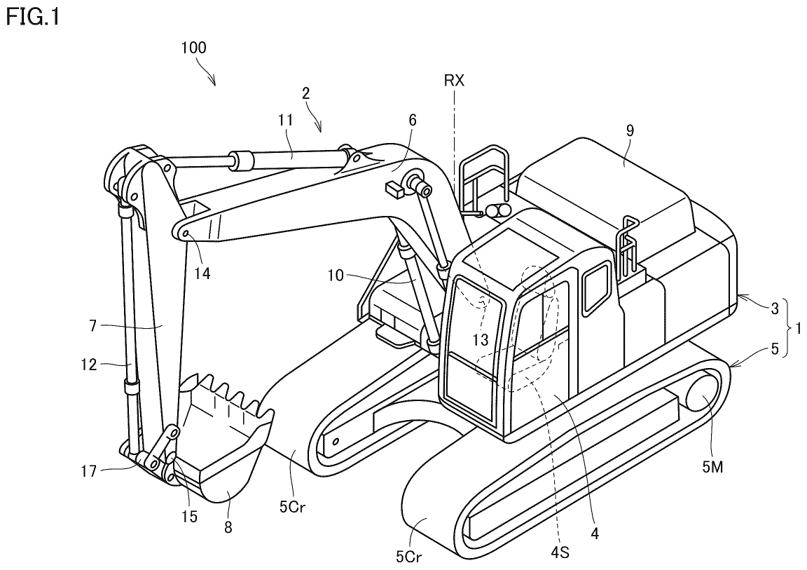

In the following description, the terms “upper”, “lower”, “front”, “rear”, “left”, and “right” indicate the directions with respect to an operator seated on an operator's seat 4S in an operator's cab 4 shown in FIG. 1.

### <Configuration of Electric Excavator>

First, a configuration of an electric excavator according to the present embodiment will be described with reference to FIG. 1.

FIG. 1 is a perspective view schematically showing a configuration of an electric excavator according to an embodiment of the present disclosure. As shown in FIG. 1, an electric excavator 100 includes a main body 1, and a work implement 2 that is hydraulically actuated. Main body 1 includes a revolving unit 3 and a traveling unit 5. Traveling unit 5 includes a pair of crawler belts 5Cr and a travel motor 5M. Electric excavator 100 can travel by rotation of crawler belts 5Cr. Travel motor 5M is provided as a driving source of traveling unit 5. Travel motor 5M is a hydraulic motor that is hydraulically actuated. Traveling unit 5 may include a wheel (tire). Travel motor 5M or a revolving motor 37 may be an electric motor.

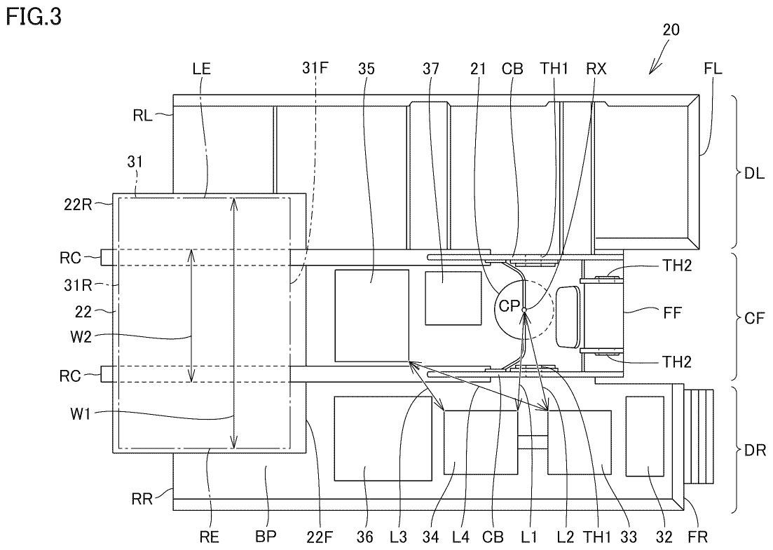

Revolving unit 3 is arranged on traveling unit 5 and supported by traveling unit 5. Revolving unit 3 can revolve about a revolution axis RX with respect to traveling unit 5 by revolving motor 37 (FIG. 3). Revolving motor 37 is a hydraulic motor that is hydraulically actuated. Revolution axis RX is an imaginary straight line serving as a center of revolution of revolving unit 3.

Revolving unit 3 includes operator's cab 4 (cab). Operator's seat 4S on which an operator is seated is provided in operator's cab 4. The operator (occupant) who is aboard operator's cab 4 can perform the control of work implement 2, the revolving control of revolving unit 3 with respect to traveling unit 5, and the traveling control of electric excavator 100 by traveling unit 5.

Revolving unit 3 includes an exterior cover 9. Exterior cover 9 covers a machine compartment. A battery, an inverter, an electric motor, a hydraulic pump, a revolving motor, a switching valve, a hydraulic oil tank and the like are arranged in the machine compartment.

Work implement 2 is supported by revolving unit 3. Work implement 2 includes a boom 6, an arm 7 and a bucket 8. Work implement 2 further includes a boom cylinder 10, an arm cylinder 11 and a bucket cylinder 12.

Boom 6 is pivotably connected to main body 1 (traveling unit 5 and revolving unit 3). Specifically, a proximal end of boom 6 is pivotably connected to revolving unit 3 about a boom foot pin 13 as a pivot point.

Arm 7 is pivotably connected to boom 6. Specifically, a proximal end of arm 7 is pivotably connected to a tip of boom 6 about a boom top pin 14 as a pivot point. Bucket 8 is rotatably connected to arm 7. Specifically, a proximal end of bucket 8 is pivotably connected to a tip of arm 7 about an arm top pin 15 as a pivot point.

One end of boom cylinder 10 is connected to revolving unit 3, and the other end thereof is connected to boom 6. Boom 6 can be driven with respect to main body 1 by boom cylinder 10. Boom 6 driven in this way can pivot about boom foot pin 13 as a pivot point in an up/down direction with respect to revolving unit 3.

One end of arm cylinder 11 is connected to boom 6, and the other end thereof is connected to arm 7. Arm 7 can be driven with respect to boom 6 by arm cylinder 11. Arm 7 driven in this way can pivot about boom top pin 14 as a pivot point in an up/down direction or a fore/aft direction with respect to boom 6.

One end of bucket cylinder 12 is connected to arm 7, and the other end thereof is connected to a bucket link 17. Bucket 8 can be driven with respect to arm 7 by bucket cylinder 12. Bucket 8 driven in this way can pivot about arm top pin 15 as a pivot point in an up/down direction with respect to arm 7.

Each of boom cylinder 10, arm cylinder 11 and bucket cylinder 12 is a hydraulic cylinder and is hydraulically driven.

### <Configuration of Revolving Frame and Arrangement of Components Mounted Thereon>

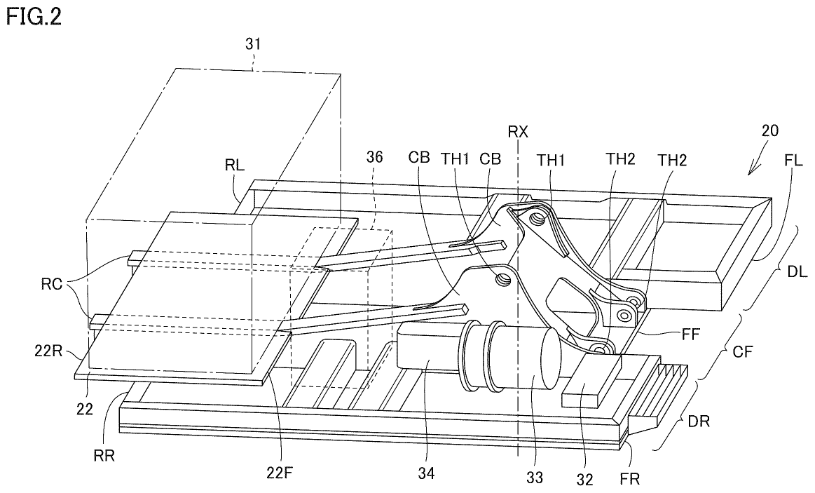

Next, a configuration of the revolving frame and arrangement of components mounted on the revolving frame in the electric excavator shown in FIG. 1 will be described with reference to FIGS. 2 and 3.

FIGS. 2 and 3 are a perspective view and a plan view showing a configuration of the revolving frame and arrangement of components mounted thereon in the electric excavator shown in FIG. 1, respectively. As shown in FIG. 2, revolving unit 3 (FIG. 1) includes a revolving frame 20. Revolving frame 20 revolves about revolution axis RX with respect to traveling unit 5 (FIG. 1).

Revolving frame 20 includes a center frame CF, a left deck DL and a right deck DR. Center frame CF is located almost in the center in a right/left direction of revolving frame 20. Left deck DL is arranged on the left side of center frame CF. Right deck DR is arranged on the right side of center frame CF.

Center frame CF includes a pair of center beams CB. The pair of center beams CB are arranged to be spaced apart from and face each other in the right/left direction. The pair of center beams CB support work implement 2 (FIG. 1). Thus, center frame CF supports work implement 2.

Each of the pair of center beams CB includes through holes TH1 and TH2.

Boom foot pin 13 (FIG. 1) is inserted through through hole TH1. Boom foot pin 13 allows boom 6 (FIG. 1) to be rotatably supported by the pair of center beams CB.

A pin (not shown) that supports boom cylinder 10 (FIG. 1) is inserted through through hole TH2. This pin allows boom cylinder 10 to be rotatably supported by center beams CB.

Each of a front end FL of left deck DL and a front end FR of right deck DR is located forward of a front end FF of center frame CF. A rear end RC of each of the pair of center beams CB is located rearward of a rear end RL of left deck DL and a rear end RR of right deck DR. Rear end RC of each of the pair of center beams CB is a rearmost end of center frame CF.

A bracket 22 is connected to a rear upper surface of the pair of center beams CB by, for example, welding and the like. A rear end 22R of bracket 22 is located forward of rear end RC of each of the pair of center beams CB and rearward of rear end RL of left deck DL and rear end RR of right deck DR. A front end 22F of bracket 22 is located forward of rear end RL of left deck DL and rear end RR of right deck DR.

As shown in FIG. 3, components such as a battery 31, an inverter 32, an electric motor 33, a hydraulic pump 34, a switching valve 35, a hydraulic oil tank 36, and a revolving motor 37 are supported by revolving frame 20. An output shaft of electric motor 33 is mechanically connected to an input shaft of hydraulic pump 34.

Battery 31 includes, for example, a plurality of battery modules and each of the plurality of battery modules includes a battery cell. Battery 31 is a power source and stores electric energy obtained from an external power source. Battery 31 takes out the stored electric energy as electromotive force. Battery 31 supplies electric power to inverter 32 through electric wiring.

Inverter 32 converts DC power, which is an output of battery 31, into AC power having the controlled frequency or the like. Inverter 32 supplies the AC power to electric motor 33 through electric wiring. Inverter 32 thereby controls driving of electric motor 33. In this way, the electric energy stored in battery 31 is supplied to electric motor 33.

Using battery 31 as a power source, electric motor 33 is driven by the AC power supplied from inverter 32. The rotation speed of electric motor 33 is controlled in accordance with the frequency of the AC power supplied from inverter 32. When electric motor 33 is driven, the driving force of electric motor 33 is transmitted to hydraulic pump 34 and hydraulic pump 34 is driven.

Hydraulic pump 34 driven supplies a hydraulic oil to each of hydraulic actuators 5M, 37 and 10 to 12 through switching valve 35 (main valve). Specifically, hydraulic pump 34 driven pumps out the hydraulic oil from hydraulic oil tank 36 through a hydraulic pipe. Hydraulic oil tank 36 serves to supply the oil to hydraulic pump 34. The hydraulic oil discharged from hydraulic pump 34 is supplied to switching valve 35 through the hydraulic pipe.

Switching valve 35 is formed as an assembly of multiple control valves, pilot valves and the like. Switching valve 35 is arranged in an oil path (hydraulic pipe) between hydraulic pump 34 and a hydraulic actuator. Switching valve 35 supplies and discharges the hydraulic oil pumped out from hydraulic oil tank 36 by hydraulic pump 34 to and from the hydraulic actuator. The hydraulic actuator includes, for example, the hydraulic cylinders (boom cylinder 10, arm cylinder 11 and bucket cylinder 12), revolving motor 37 and travel motor 5M. Each of hydraulic actuators 5M, 37 and 10 to 12 is actuated by supply and discharge of the hydraulic oil to and from switching valve 35.

Opening and closing of each valve in switching valve 35 are controlled in accordance with the operation control by the operator. Main body 1 and work implement 2 of electric excavator 100 can thereby be actuated in accordance with the operation control by the operator who is aboard operator's cab 4. Specifically, the operator can control work implement 2 by actuating hydraulic cylinders 10 to 12, can control revolution of revolving unit 3 by actuating revolving motor 37, and can control traveling of electric excavator 100 by actuating travel motor 5M.

Battery 31 is arranged on bracket 22 and thereby supported by revolving frame 20. A dimension W1 of battery 31 in the right/left direction is larger than a dimension W2 of center frame CF in the right/left direction. Dimension W1 of battery 31 in the right/left direction refers to a dimension from a right end RE to a left end LE of battery 31. Dimension W2 of center frame CF in the right/left direction refers to a dimension from a right end to a left end of center frame CF.

Therefore, in a plan view, right end RE of battery 31 is located directly above right deck DR, and left end LE of battery 31 is located directly above left deck DL. The plan view herein refers to a viewpoint from top to bottom in the direction orthogonal to a bottom plate BP of revolving frame 20 (up/down direction).

Electric excavator 100 according to the present embodiment does not include a counterweight and battery 31 serves as a counterweight. Therefore, battery 31 is arranged in a rear part of revolving unit 3.

A region located rearward of each of rear end RL of left deck DL and rear end RR of right deck DR is essentially a region where a counterweight is arranged. Battery 31 includes a portion located rearward of each of rear end RL of left deck DL and rear end RR of right deck DR in a plan view so as to serve as a counterweight. Therefore, a rear end 31R of battery 31 is located rearward of each of rear end RL of left deck DL and rear end RR of right deck DR in a plan view.

However, in a large-sized electric excavator, the size of battery 31 is also large. When the height of the battery becomes high, the rear visibility of the operator seated in operator's seat 4S becomes worse. Therefore, battery 31 cannot be entirely housed within the region where the counterweight is arranged, and protrudes into the machine compartment. Therefore, a front end 31F of battery 31 is located forward of each of rear end RL of left deck DL and rear end RR of right deck DR in a plan view. As battery 31 protrudes into the machine compartment in this way, the arrangement of the components other than battery 31 is limited.

The machine compartment refers to a space located forward of each of rear end RL of left deck DL and rear end RR of right deck DR, and covered by exterior cover 9.

In the present embodiment, each of inverter 32, electric motor 33, hydraulic pump 34, and hydraulic oil tank 36 is supported by right deck DR. Each of inverter 32, electric motor 33, hydraulic pump 34, and hydraulic oil tank 36 is arranged on the front side (on the front end FR side of right deck DR) with respect to battery 31.

Hydraulic oil tank 36, hydraulic pump 34, electric motor 33, and inverter 32 are arranged in this order from the rear end RR side toward the front end FR side of right deck DR. That is, hydraulic oil tank 36 is arranged forward of battery 31, hydraulic pump 34 is arranged forward of hydraulic oil tank 36, electric motor 33 is arranged forward of hydraulic pump 34, and inverter 32 is arranged forward of electric motor 33.

In a plan view, gaps are provided between front end 31F of battery 31 and a rear end of hydraulic oil tank 36, between a front end of hydraulic oil tank 36 and a rear end of hydraulic pump 34, and between a front end of electric motor 33 and a rear end of inverter 32.

The rear end of hydraulic pump 34 is located on the rear side (on the rear end RR side of right deck DR) with respect to the position of through hole TH1 in the fore/aft direction. The rear end of electric motor 33 is located on the front side (on the front end FR side of right deck DR) with respect to the position of through hole TH1 in the fore/aft direction. The rear end of inverter 32 is located on the front side (on the front end FR side of right deck DR) with respect to the position of front end FF of center frame CF in the fore/aft direction.

Hydraulic oil tank 36 is arranged between hydraulic pump 34 and battery 31 in a plan view. Hydraulic pump 34 is arranged closer to battery 31 than electric motor 33 in a plan view.

Each of switching valve 35 and revolving motor 37 is supported by center frame CF. Each of switching valve 35 and revolving motor 37 is arranged in a region sandwiched between the pair of center beams CB in a plan view.

Each of switching valve 35 and revolving motor 37 is arranged on the front side (on the front end FF side of center frame CF) with respect to battery 31.

Switching valve 35 and revolving motor 37 are arranged in this order from the rear end RC side toward the front end FF side of center frame CF. That is, switching valve 35 is arranged forward of battery 31, and revolving motor 37 is arranged forward of switching valve 35. Switching valve 35 is arranged between battery 31 and revolving motor 37, and is arranged closer to battery 31 than revolving motor 37.

An opening 21 is arranged forward of revolving motor 37. Opening 21 is a through hole provided in bottom plate BP of revolving frame 20. A swivel joint (not shown) is, for example, inserted through opening 21. Opening 21 has a substantially circular shape in a plan view. A projection that projects from a circumferential edge portion to the inner circumferential side of circular opening 21 may be provided to fix a body of the swivel joint. Revolution axis RX passes through a center of substantially circular opening 21 in a plan view. Therefore, a center CP of substantially circular opening 21 in a plan view serves as a center of revolution (center of rotation) of revolving unit 3 with respect to traveling unit 5. That is, revolving frame 20 revolves around center of revolution CP.

Hydraulic pump 34 is arranged closer to center of revolution CP (revolution axis RX) than electric motor 33 in a plan view. Specifically, in a plan view, a shortest distance L1 between center of revolution CP and hydraulic pump 34 is smaller than a shortest distance L2 between center of revolution CP and electric motor 33.

Hydraulic pump 34 is arranged closer to switching valve 35 than electric motor 33. Specifically, in a plan view, a shortest distance L3 between switching valve 35 and hydraulic pump 34 is smaller than a shortest distance L4 between switching valve 35 and electric motor 33.

Operator's cab 4 (FIG. 1) is supported by a front part of left deck DL. Each of inverter 32, electric motor 33, hydraulic pump 34, and hydraulic oil tank 36 may be supported by left deck DL and operator's cab 4 may be arranged on right deck DR.

Although the configuration in which the hydraulic pump and the hydraulic oil tank are arranged in the fore/aft direction has been described in the embodiment above, the hydraulic pump and the hydraulic oil tank may be arranged vertically.

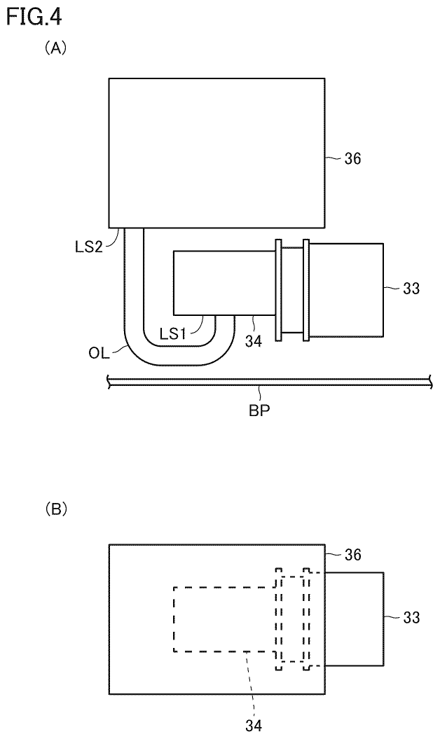

FIG. 4 is a side view (A) and a plan view (B) showing a state in which the hydraulic pump is arranged under the hydraulic oil tank. As shown in FIGS. 4(A) and 4(B), hydraulic oil tank 36 is arranged directly above hydraulic pump 34. Therefore, in a plan view shown in FIG. 4(B), hydraulic pump 34 as a whole is superimposed on hydraulic oil tank 36. When hydraulic oil tank 36 is arranged in a front part of right deck DR unlike the arrangement in FIG. 3, hydraulic oil tank 36 may be located directly above electric motor 33. In this case, a part or the whole of electric motor 33 is superimposed on hydraulic oil tank 36.

As shown in FIG. 4(A), in this arrangement, a lower surface LS2 of hydraulic oil tank 36 is located above hydraulic pump 34. Therefore, an oil pipe OL that connects hydraulic oil tank 36 and hydraulic pump 34 is connected to lower surface LS2 of hydraulic oil tank 36 at a position higher than hydraulic pump 34. Oil pipe OL extends downward from the portion connected to hydraulic oil tank 36 behind hydraulic pump 34, and then, extends through a space between a lower surface LS1 of hydraulic pump 34 and bottom plate BP of revolving frame 20 and is connected to lower surface LS1 of hydraulic pump 34.

### <Effects>

Next, effects of the present embodiment will be described.

As shown in FIG. 3, supply of the hydraulic oil from switching valve 35 to travel motor 5M (FIG. 1) is performed through the swivel joint inserted into opening 21 of revolving frame 20. In addition, revolving motor 37 is arranged near center of revolution CP in order to engage a rotation shaft of revolving motor 37 with a revolving gear. Furthermore, work implement 2 is supported by revolving frame 20 near center of revolution CP.

Therefore, by arranging switching valve 35 near center of revolution CP, the length of the hydraulic pipe extending from switching valve 35 to each of travel motor 5M, revolving motor 37 and hydraulic cylinders 10 to 12 can be shortened. Therefore, by arranging hydraulic pump 34 near center of revolution CP, the length of the hydraulic pipe extending from hydraulic pump 34 to switching valve 35 can also be shortened.

In the present embodiment, as shown in FIG. 3, hydraulic pump 34 is arranged closer to center of revolution CP than electric motor 33 in a plan view. Therefore, as described above, the length of the hydraulic pipe extending from hydraulic pump 34 through switching valve 35 to each of hydraulic actuators 5M, 37 and 10 to 12 can be shortened. Thus, a loss of oil pressure can be reduced and good energy efficiency is obtained.

In addition, according to the present embodiment, as shown in FIG. 3, hydraulic pump 34 is arranged closer to switching valve 35 than electric motor 33. Therefore, the length of the hydraulic pipe extending from hydraulic pump 34 to switching valve 35 can be shortened. Thus, a loss of oil pressure from hydraulic pump 34 to switching valve 35 can be further reduced and better energy efficiency is obtained.

In addition, according to the present embodiment, as shown in FIG. 3, electric motor 33 and hydraulic pump 34 are supported by any one of right deck DR and left deck DL. Therefore, even when battery 31 increases in size, electric motor 33 and hydraulic pump 34 can be arranged on revolving frame 20.

In addition, according to the present embodiment, as shown in FIG. 3, battery 31 includes the portion located rearward of the position of rear end RR of right deck DR and rear end RL of left deck DL in the fore/aft direction. Thus, battery 31 can function as a counterweight.

In addition, according to the present embodiment, as shown in FIG. 3, switching valve 35 is arranged in the region sandwiched between the pair of center beams CB in a plan view. Thus, the length of the hydraulic pipe extending from switching valve 35 to each of hydraulic actuators 5M, 37 and 10 to 12 can be shortened.

In addition, according to the present embodiment, as shown in FIG. 3, hydraulic oil tank 36 is arranged between hydraulic pump 34 and battery 31 in a plan view. Thus, the length of the oil pipe that connects hydraulic pump 34 and hydraulic oil tank 36 can be shortened.

In addition, according to the present embodiment, as shown in FIG. 4, hydraulic pump 34 is arranged under hydraulic oil tank 36. Thus, the oil intake property by hydraulic pump 34 becomes better. In addition, by arranging hydraulic pump 34 and hydraulic oil tank 36 vertically, hydraulic pump 34 and hydraulic oil tank 36 can be arranged in the fore/aft direction in a compact manner.

In addition, according to the present embodiment, as shown in FIG. 3, inverter 32 is arranged forward of electric motor 33. Thus, the length of the electric wiring that connects inverter 32 and electric motor 33 can be shortened.

When electric excavator 100 is remotely controlled and the operator does not need to get aboard electric excavator 100, operator's cab 4 may be omitted.

It should be understood that the embodiment disclosed herein is illustrative and non-restrictive in every respect. The scope of the present disclosure is defined by the terms of the claims, rather than the description above, and is intended to include any modifications within the scope and meaning equivalent to the terms of the claims.

### REFERENCE SIGNS LIST

1 main body; 2 work implement; 3 revolving unit; 4 operator's cab; 4S operator's seat; 5 traveling unit; 5Cr crawler belt; 5M travel motor; 6 boom; 7 arm; 8 bucket; 9 exterior cover; 10 boom cylinder; 11 arm cylinder; 12 bucket cylinder; 13 boom foot pin; 14 boom top pin; 15 arm top pin; 17 bucket link; 20 revolving frame; 21 opening; 22 bracket; 22F, 31F, FF, FL, FR front end; 22R, 31R, RC, RL, RR rear end; 31 battery; 32 inverter, 33 electric motor; 34 hydraulic pump; 35 switching valve; 36 hydraulic oil tank; 37 revolving motor, 100 electric excavator, BP bottom plate; CB center beam; CF center frame; CP center of revolution; DL left deck; DR right deck; LE left end; LS1, LS2 lower surface; OL oil pipe; RE right end; RX revolution axis (center of revolution); TH1, TH2 through hole.

1. An electric excavator comprising:
a hydraulic actuator;
a revolving frame that revolves around a center of revolution;
a battery supported by the revolving frame;
an electric motor supported by the revolving frame and driven by using the battery as a power source; and
a hydraulic pump supported by the revolving frame, driven by the electric motor to supply oil to the hydraulic actuator, and arranged closer to the center of revolution than the electric motor in a plan view.

2. The electric excavator according to claim 1, further comprising a switching valve arranged in an oil path between the hydraulic pump and the hydraulic actuator, wherein
the hydraulic pump is arranged closer to the switching valve than the electric motor.

3. The electric excavator according to claim 2, wherein
electric energy stored in the battery is supplied to the electric motor,
the electric motor is driven by supply of the electric energy, and
the oil from the hydraulic pump is supplied to the hydraulic actuator through the switching valve by driving of the electric motor.

4. The electric excavator according to claim 2, further comprising a work implement, wherein
the revolving frame includes a center frame that supports the work implement, and a deck arranged on either a right side or a left side of the center frame, and
the electric motor and the hydraulic pump are supported by the deck.

5. The electric excavator according to claim 4, wherein
the battery is arranged to include a portion located rearward of a rear end position of the deck.

6. The electric excavator according to claim 4, wherein
the center frame includes a pair of center beams that support the work implement, and
the switching valve is arranged in a region sandwiched between the pair of center beams in a plan view.

7. The electric excavator according to claim 1, further comprising a hydraulic oil tank that supplies oil to the hydraulic pump, wherein
the hydraulic oil tank is arranged between the hydraulic pump and the battery in a plan view.

8. The electric excavator according to claim 1, further comprising a hydraulic oil tank that supplies oil to the hydraulic pump, wherein
the hydraulic pump is arranged under the hydraulic oil tank.

9. The electric excavator according to claim 1, further comprising an inverter that controls driving of the electric motor, wherein
the inverter is arranged forward of the electric motor.

10. The electric excavator according to claim 1, further comprising a work implement, wherein
the hydraulic actuator is a hydraulic cylinder that drives the work implement.
